(19) United States
(12) Patent Application Publication
(10) Pub. No.: US 2026/0025742 A1
(43) Pub. Date: Jan. 22, 2026

(54) METHODS AND COMMUNICATIONS DEVICES

(71) Applicant: Sony Group Corporation, Tokyo (JP)

(72) Inventors: Yuxin WEI, Basingstoke (GB); Vivek SHARMA, Basingstoke (GB); Hideji WAKABAYASHI, Basingstoke (GB); Yassin Aden AWAD, Basingstoke (GB)

(73) Assignee: Sony Group Corporation, Tokyo (JP)

(21) Appl. No.: 18/997,223

(22) PCT Filed: Jul. 21, 2023
(86) PCT No.: PCT/EP2023/070368

§ 371 Date: Jan. 21, 2025

(30) Foreign Application Priority Data
Jul. 28, 2022 (EP) 22187657.6

(51) Int. Cl. H04W 48/16; H04W 4/38; H04W 92/18

(52) U.S. Cl. CPC H04W 48/16; H04W 4/38; H04W 92/18

(57) ABSTRACT

Examples of the present technique can provide methods, apparatus and circuitry for operating a communications device configured to transmit signals to and/or receive signals from an infrastructure equipment of a wireless communications network and/or one or more other communications devices. The method comprises transmitting, to one or more network devices, one or more requests for sensing capability discovery, wherein the one or more network devices comprise the infrastructure equipment or the one or more other communications devices. The method also comprises receiving, from the one or more network devices, one or more responses to the sensing capability discovery request.

The present application claims the Paris Convention priority of European patent application EP22187657.6, filed 28 Jul. 2022, the contents of which are hereby incorporated by reference.

### BACKGROUND

### Field of Disclosure

The present disclosure relates to communications devices, infrastructure equipment and methods for assisting the sensing capability discovery of communications devices in a wireless communications network.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Previous generation mobile telecommunication systems, such as those based on the 3GPP defined UMTS and Long Term Evolution (LTE) architecture, are able to support a wider range of services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

Current and future wireless communications networks are expected to routinely and efficiently support communications with an ever-increasing range of devices associated with a wider range of data traffic profiles and types than existing systems are optimised to support. For example, it is expected future wireless communications networks will be expected to efficiently support communications with devices including reduced complexity devices, machine type communication (MTC) devices, high resolution video displays, virtual reality headsets, extended Reality (XR) and so on. Some of these different types of devices may be deployed in very large numbers, for example low complexity devices for supporting the “The Internet of Things”, and may typically be associated with the transmissions of relatively small amounts of data with relatively high latency tolerance. Other types of device, for example supporting high-definition video streaming, may be associated with transmissions of relatively large amounts of data with relatively low latency tolerance. Other types of device, for example used for autonomous vehicle communications and for other critical applications, may be characterised by data that should be transmitted through the network with low latency and high reliability. A single device type might also be associated with different traffic profiles/characteristics depending on the application(s) it is running. For example, different consideration may apply for efficiently supporting data exchange with a smartphone when it is running a video streaming application (high downlink data) as compared to when it is running an Internet browsing application (sporadic uplink and downlink data) or being used for voice communications by an emergency responder in an emergency scenario (data subject to stringent reliability and latency requirements).

In view of this there is expected to be a desire for current wireless communications networks, for example those which may be referred to as 5G or new radio (NR) systems/new radio access technology (RAT) systems, or indeed future 6G wireless communications, as well as future iterations/releases of existing systems, to efficiently support connectivity for a wide range of devices associated with different applications and different characteristic data traffic profiles and requirements.

One example of a new service is referred to as Ultra Reliable Low Latency Communications (URLLC) services which, as its name suggests, requires that a data unit or packet be communicated with a high reliability and with a low communications delay. Another example of a new service is extended Reality (XR), which may be provided by various user equipment such as wearable devices. XR combines real-world and virtual environments, incorporating aspects such as augmented reality (AR), mixed reality (MR), and virtual reality (VR), and thus requires high quality and minimised interaction delay. Services such as URLLC and XR therefore represent a challenging example for both LTE type communications systems and 5G/NR communications systems, as well as future generation communications systems.

With the expected increase in VR and XR services, and particularly with the anticipated rise in deployments of technology in areas such as Vehicle-to-X, V2X, it is anticipated that coordinated sensing will be necessary, and will increasingly be made possible by the development of the Internet of Things, IoT, and MTC devices.

### SUMMARY OF THE DISCLOSURE

The present disclosure can help address or mitigate at least some of the issues discussed above.

Examples of the present technique can provide methods, apparatus and circuitry for operating a communications device configured to transmit signals to and/or receive signals from an infrastructure equipment of a wireless communications network and/or one or more other communications devices. The method comprises transmitting, to one or more network devices, one or more requests for sensing capability discovery, wherein the one or more network devices comprise the infrastructure equipment or the one or more other communications devices. The method also comprises receiving, from the one or more network devices, one or more responses to the sensing capability discovery request.

Other examples of the present technique can provide methods, apparatus and circuitry for operating an infrastructure equipment configured to transmit signals to and/or receive signals from a communications device in a wireless communications network. The method comprises receiving, from the communications device, a request for sensing capability discovery, and transmitting, to the communications device, a response to the sensing capability discovery request.

Yet further examples of the present technique can provide methods, apparatus and circuitry for operating an infrastructure equipment configured to transmit signals to and/or receive signals from a communications device in a wireless communications network according to a method. The method comprises transmitting, to the communications device, an indication of sensing capability of the infrastructure equipment and/or an indication of sensing capability of one or more neighbouring communications devices associated with the infrastructure equipment.

A final example of the present technique can provide methods, apparatus and circuitry for operating a communications device configured to transmit signals to and/or receive signals from an infrastructure equipment of a wireless communications network and/or one or more other communications devices according to a method. The method comprises receiving, from one other communications device, a request for sensing capability discovery, and transmitting, to the other communications device, a response to the sensing capability discovery request.

Embodiments of the present technique, which, in addition to methods of operating communications devices, relate to communications devices, circuitry for communications devices, computer programs, and computer-readable storage mediums, can allow for more sustainable and efficient use of radio resources by a communications device operating in a wireless communications network.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain examples of the present disclosure;

FIG. 2 schematically represents some aspects of a new radio access technology (RAT) wireless telecommunications system which may be configured to operate in accordance with certain examples of the present disclosure;

FIG. 3 is a schematic block diagram of an example infrastructure equipment and communications device which may be configured to operate in accordance with certain examples of the present disclosure;

FIG. 4 represents a message flow diagram between two peer communications devices which may be adapted in accordance with certain examples of the present disclosure;

FIG. 5 represents a message flow diagram between a communications device and an infrastructure equipment that may be adapted in accordance with certain examples of the present disclosure; and

FIG. 6 shows a flow diagram to be implemented by a communications device in accordance with certain examples of the present disclosure.

### DETAILED DESCRIPTION OF THE EMBODIMENTS

### Long Term Evolution Advanced Radio Access Technology (4G)

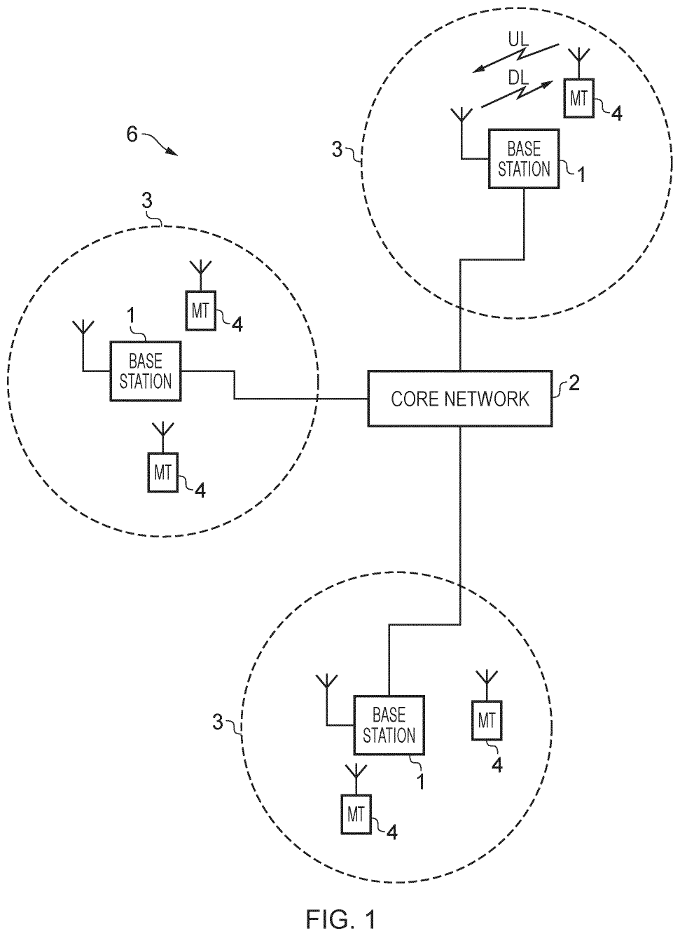

FIG. 1 provides a schematic diagram illustrating some basic functionality of a mobile telecommunications network/system 6 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP (RTM) body, and also described in many books on the subject, for example, Holma H. and Toskala A [1]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 6 includes a plurality of base stations 1 connected to a core network 2. Each base station provides a coverage area 3 (i.e. a cell) within which data can be communicated to and from communications devices 4. Although each base station 1 is shown in FIG. 1 as a single entity, the skilled person will appreciate that some of the functions of the base station may be carried out by disparate, inter-connected elements, such as antennas (or antennae), remote radio heads, amplifiers, etc. Collectively, one or more base stations may form a radio access network.

Data is transmitted from base stations 1 to communications devices 4 within their respective coverage areas 3 via a radio downlink. Data is transmitted from communications devices 4 to the base stations 1 via a radio uplink. The core network 2 routes data to and from the communications devices 4 via the respective base stations 1 and provides functions such as authentication, mobility management, charging and so on. Terminal devices may also be referred to as mobile stations, user equipment (UE), user terminal, mobile radio, communications device, and so forth. Services provided by the core network 2 may include connectivity to the internet or to external telephony services. The core network 2 may further track the location of the communications devices 4 so that it can efficiently contact (i.e. page) the communications devices 4 for transmitting downlink data towards the communications devices 4.

Base stations, which are an example of network infrastructure equipment, may also be referred to as transceiver stations, nodeBs, e-nodeBs, eNB, g-nodeBs, gNB and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G)

Systems incorporating NR technology are expected to support different services (or types of services), which may be characterised by different requirements for latency, data rate and/or reliability. For example, Enhanced Mobile Broadband (eMBB) services are characterised by high capacity with a requirement to support up to 20 Gb/s. The requirements for Ultra Reliable and Low Latency Communications (URLLC) services are for one transmission of a 32 byte packet to be transmitted from the radio protocol layer 2/3 SDU ingress point to the radio protocol layer 2/3 SDU egress point of the radio interface within 1 ms with a reliability of 1-10⁻⁵ (99.999%) or higher (99.9999%) [2].

Massive Machine Type Communications (mMTC) is another example of a service which may be supported by NR-based communications networks. In addition, systems may be expected to support further enhancements related to Industrial Internet of Things (IIoT) in order to support services with new requirements of high availability, high reliability, low latency, and in some cases, high-accuracy positioning.

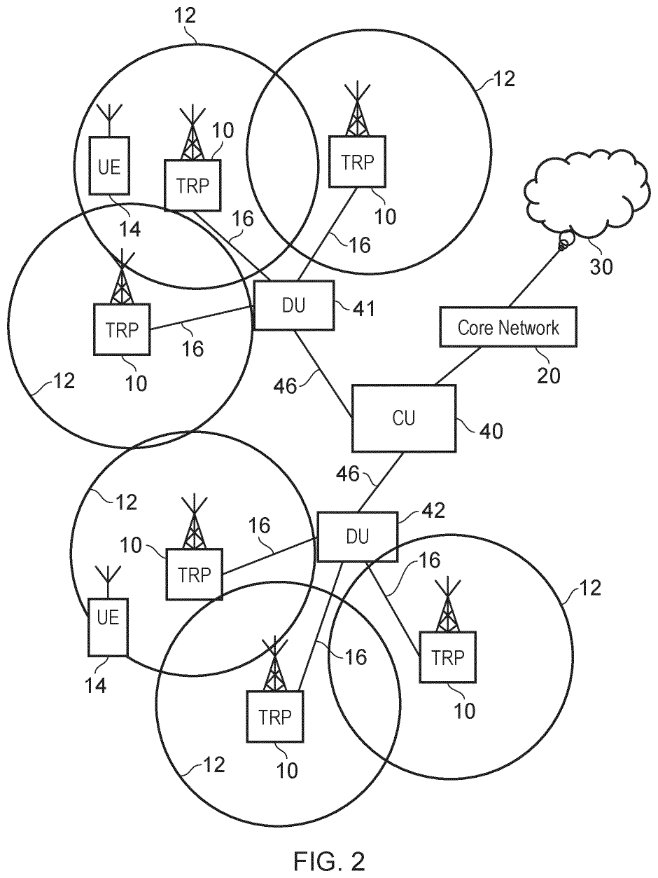

An example configuration of a wireless communications network which uses some of the terminology proposed for and used in NR and 5G is shown in FIG. 2. In FIG. 2 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to the core network 20 which may contain all other functions required to transmit data for communicating to and from the wireless communications devices and the core network 20 may be connected to other networks 30.

The elements of the wireless access network shown in FIG. 2 may operate in a similar way to corresponding elements of an LTE network as described with regard to the example of FIG. 1. It will be appreciated that operational aspects of the telecommunications network represented in FIG. 2, and of other networks discussed herein in accordance with embodiments of the disclosure, which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The TRPs 10 of FIG. 2 may in part have a corresponding functionality to a base station or eNodeB of an LTE network. Similarly, the communications devices 14 may have a functionality corresponding to the UE devices 4 known for operation with an LTE network. It will be appreciated therefore that operational aspects of a new RAT network (for example in relation to specific communication protocols and physical channels for communicating between different elements) may be different to those known from LTE or other known mobile telecommunications standards. However, it will also be appreciated that each of the core network component, base stations and communications devices of a new RAT network will be functionally similar to, respectively, the core network component, base stations and communications devices of an LTE wireless communications network.

In terms of broad top-level functionality, the core network 20 connected to the new RAT telecommunications system represented in FIG. 2 may be broadly considered to correspond with the core network 2 represented in FIG. 1, and the respective central units 40 and their associated distributed units/TRPs 10 may be broadly considered to provide functionality corresponding to the base stations 1 of FIG. 1. The term network infrastructure equipment/access node may be used to encompass these elements and more conventional base station type elements of wireless telecommunications systems. Depending on the application at hand the responsibility for scheduling transmissions which are scheduled on the radio interface between the respective distributed units and the communications devices may lie with the controlling node/central unit and/or the distributed units/TRPs. A communications device 14 is represented in FIG. 2 within the coverage area of the first communication cell 12. This communications device 14 may thus exchange signalling with the first central unit 40 in the first communication cell 12 via one of the distributed units/TRPs 10 associated with the first communication cell 12.

It will further be appreciated that FIG. 2 represents merely one example of a proposed architecture for a new RAT based telecommunications system in which approaches in accordance with the principles described herein may be adopted, and the functionality disclosed herein may also be applied in respect of wireless telecommunications systems having different architectures.

Thus, certain embodiments of the disclosure as discussed herein may be implemented in wireless telecommunication systems/networks according to various different architectures, such as the example architectures shown in FIGS. 1 and 2. It will thus be appreciated the specific wireless telecommunications architecture in any given implementation is not of primary significance to the principles described herein. In this regard, certain embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 1 as shown in FIG. 1 which is adapted to provide functionality in accordance with the principles described herein, and in other examples the network infrastructure equipment may comprise a control unit/controlling node 40 and/or a TRP 10 of the kind shown in FIG. 2 which is adapted to provide functionality in accordance with the principles described herein.

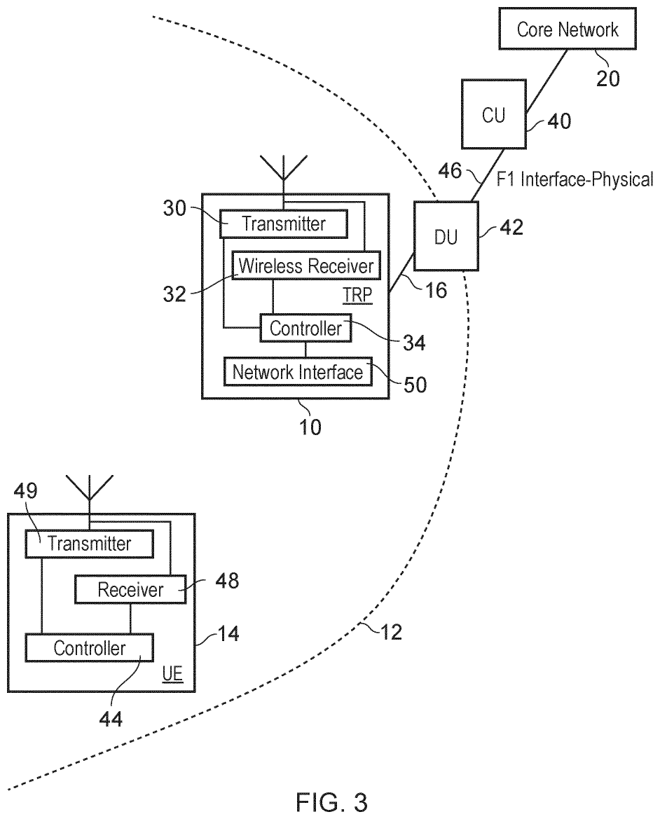

A more detailed diagram of some of the components of the network shown in FIG. 2 is provided by FIG. 3. In FIG. 3, a TRP 10 as shown in FIG. 2 comprises, as a simplified representation, a wireless transmitter 30, a wireless receiver 32 and a controller or controlling processor 34 which may operate to control the transmitter 30 and the wireless receiver 32 to transmit and receive radio signals to one or more UEs 14 within a cell 12 formed by the TRP 10. As shown in FIG. 3, an example UE 14 is shown to include a corresponding transmitter 49, a receiver 48 and a controller 44 which is configured to control the transmitter 49 and the receiver 48 to transmit signals representing uplink data to the wireless communications network via the wireless access interface formed by the TRP 10 and to receive downlink data as signals transmitted by the transmitter 30 and received by the receiver 48 in accordance with the conventional operation.

The transmitters 30, 49 and the receivers 32, 48 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controllers 34, 44 (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium. The transmitters, the receivers and the controllers are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment/TRP/base station as well as the UE/communications device will in general comprise various other elements associated with its operating functionality.

As shown in FIG. 3, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface. The F1 interface 46 between CU and DU may operate in accordance with specifications 3GPP TS 38.470 and 3GPP TS 38.473, and may be formed from a fibre optic or other wired or wireless high bandwidth connection. In one example the connection 16 from the TRP 10 to the DU 42 is via fibre optic. The connection between a TRP 10 and the core network 20 can be generally referred to as a backhaul, which comprises the interface 16 from the network interface 50 of the TRP 10 to the DU 42 and the F1 interface 46 from the DU 42 to the CU 40.

### Integrated Sensing and Communication

Recent areas of interest in this field relate to integrated sensing and communication [3], particularly wireless sensing and the applications that this may have in future technology with respect to vehicles and vehicle-based technology systems.

Wireless sensing is the acquisition of information related to a remote object and its characteristics without any physical contact with the object itself. Data relating to the perception of the object and its surroundings may be analysed by a communications device, and characteristics of the object may be determined from this analysis process. For example, a common form of wireless sensing is radar, which may use radio waves to determine at least the distance to, angle of, and/or instantaneous velocity of, a remote object without any physical contact between the object and a sensing device such as a radar gun. Other radio-frequency, RF, sensing techniques are available, in addition to non-RF sensing techniques such as time-of-flight cameras, accelerometers, gyroscopes, and Lidar.

Integrated sensing and communication include at least two scenarios, which can be broadly divided into communication assisted sensing and sensing assisted communication. Communication assisted sensing may be thought of e.g. as a communication system, and the operation thereof, providing sensing services. Sensing assisted communication may be thought of, e.g. as when sensing information related to a communication channel or environment is used to improve a communication service of a communication system itself. For example, sensing information may be used to assist radio resource management, interference mitigation, beam management, mobility etc. of a communications system such as a 5G wireless communications network.

With regard to the first of these scenarios, communication assisted sensing, there are a number of services where this technology might be employed. One example of these include real-time monitoring of the environment of a communication system. That is to say, wireless signals may be used to reconstruct a local environment map, with the aim of further improving positioning accuracy and enabling environment related applications. Such environment related applications may include the creation and maintenance of a dynamic 3D map for driving assistance, pedestrian flow statistics, intrusion detection, etc. Another example may include the application of communication assisted sensing to autonomous vehicles or unmanned aerial vehicles, which, although different, have some common functional requirements and so have been amalgamated here for the sake of brevity. For example, both autonomous vehicles and UAVs may support Detect and Avoid, DAA, procedures to avoid obstacles and collisions. Furthermore, both may have capability for monitoring path information, such as traffic monitoring, selection of routes, complying with traffic regulations etc.

Another example of using communication assisted sensing would be the monitoring of air pollution. The quality of a received wireless signal displays different attenuation characteristics and coefficients as a function of air humidity, air particulate matter, PM, concentration, carrier frequency, etc. It is anticipated that this may be used for weather and air quality monitoring and detection. A final example related to communication assisted sensing is the application of this technology to indoor healthcare and intrusion detection. A number of medical and healthcare objectives may be achieved using this technology, such as estimation of respiration rate, estimation of breathing depth, apnoea detection, monitoring of vital signs of elders and infants, and indoor intrusion detection.

Sensing assisted communication also has a number of potential applications, and the sensing of wireless communication channels and the surrounding environment could further improve the performance of communication systems. Some examples of sensing assisted communications include narrowing a beam sweeping range and shortening a beam training time as a result of sensing a user equipment/communications device's location and channel environment. This may have benefits of reducing a time required to establish a connection between a communications device and a wireless communications network, and thus reduce both interference of signals on a wireless access interface and power consumption. Another application relates to prediction. Through sensing a communications device's location, velocity, motion trajectory and channel environment, either as a standalone procedure or as part of a beamforming process described above, overheads of communications related to beam measurement and the delay of beam tracking may be reduced. Furthermore, sensing of a communications device's properties and channel environment may allow improvements with respect to a channel estimation for communication between the communications device and the wireless access network.

Coordinated sensing operations enable sensors to collaborate and exchange sensing information, with the aim to improve sensing reliability and quality [4]. However, to support this future development, a number of requirements may be necessary. For example, in an automotive use case, the 5G system may need to support functionalities enabling collaborative communication and sensing, including communications devices supporting NR-based sensing capabilities or other non-NR based sensors. They may be required to collaborate with the network and/or with other communications devices in this.

The system employing this coordinated sensing operation may be required to assist communications devices with sensing capabilities in discovery and coordination processes, and may provide authorization and configuration to a communications device to establish a communication connection for sensing collaboration. This may include particular processes related to when the communications device is located in specific geographical areas, or when other predetermined conditions are met, in which the sensing operation is required or allowed. This communication connection used for sensing collaboration may include direct communication with other vehicles, communication with 5G systems via base station(s), or with relay device(s).

Furthermore, various authorized 3^{rd} parties may have access via the communications network system to the communications devices' sensing data, capabilities, and configuration. In some examples, this may be to facilitate 3^{rd} party control and coordination of sensing inputs from one or more sensing communications device.

Within this context, various examples of the present disclosure address the problem of supporting communication assisted sensing, particularly as it relates to coordinated sensing and the sharing of related data between communications devices. To address the overarching problem, a number of stages are necessary, such as, for example, the discovery of sensing capability, establishment of a sensing based connection, a sensing based service request, and the creation of a group for coordinated sensing. As would be apparent to the skilled person, in some scenarios, elements of the above process are not necessary, and may be omitted, e.g. forming a group for coordinated sensing, and elements not disclosed above may be necessary, and may be performed in line with the technical knowledge that the skilled person possesses. Furthermore, the elements of the process outlined above may be performed in an order different to that outlined, such as for instance the service request and connection establishment taking place in a single step. In particular, the present disclosure relates to the first of the above steps, that of a sensing capability discovery procedure.

### Sensing Capability Discovery

In order to enable the efficient sharing of sensing capability between communications devices, it may be necessary to discover and/or share the sensing capability of sensors between communications devices. These other sensors may be other communications devices, or a central unit, such as an infrastructure equipment (e.g. a gNB), road-side unit (RSU), or relay node, where the central unit may relay its own sensing capabilities or that of communications devices connected to the central unit, in some examples and in keeping with certain conditions such as privacy policies.

Information related to these sensors may also be shared, such as a technology that the sensing capability is based on, an accuracy of the sensing capability, a range of the sensing capability, whether the sensor is able to be coordinated or not, and other relevant information. Example information related to sensing capability for an example radar sensor may include.
Type of sensor (e.g. mmWave radar 24 GHz, 79 GHz)
A range of the sensor (distance e.g. short range, medium range, long range).
Detectable range (angle e.g. wide angle, narrow angle).
Accuracy/resolution (range, velocity e.g. 50 cm range resolution).
Type of output data (raw data, processed data, meta data)
Type of activation (always on, occasionally on, on-demand).
Policy of data sharing (allowed, not allowed due to privacy policy)
Cost of sensor activation (power consumption e.g. battery operation).

Sensing capability may be based on a Device-to-Device, D2D mode (where, for example, sensor A and sensor B exchange sensing capability information) or it may be based on a central mode (sensors may send sensing capability request to a central unit e.g. relay node, RSU, or base station). Users may be able to control a policy of data sharing from the sensor. For example, a user may not want to share data from the sensor (e.g. video data, location information etc.) because of privacy concerns and for privacy protection. Therefore, in this case, the sensor may not be permitted to share data with another sensor or with the central unit, except for in a predetermined set of situations such as an emergency situation like a traffic accident, or to comply with legal requirements, or if involved in a criminal case.

Some sensors may usually be in a power-off mode in order to minimise power consumption, and may be activated only when required to make readings. For example, GNSS in a communications device typically consumes a large amount of power, relative to the other functions of the communications device. In this case, GNSS may only be activated when an accurate position of the communications device is required; it may be in the power-off mode when not required. On the other hand, for example, a sensor in a car may always be active while the engine of the car is running. Therefore, it may be important to be aware of a cost of sensor activation in addition to hardware capability.

It is anticipated that in certain examples of the present disclosure, the capability can be contained in a container in order to support forward capability development, that is, to support the integration of future sensors with new capability. The container allows for the future introduction of new sensors and corresponding capabilities. Based on sensing capability discovery, a communications device can determine with whom: it is going to connect in order to exchange sensing information, it is going to collaborate in order to perform coordinated sensing e.g. transmission parameters adjustment; and/or it is going to ask a central unit to request/assist coordinated sensing.

In a first example, signalling for sensing capability discovery may be performed in a device-to-device, or D2D, mode. In this example, a communications device communicates directly with another communications device, or sensor, and determines through the exchange of signals representing data and information whether sensing information may be shared, along with relevant information related to this sensing information. The transmission of signals disclosed here may be based on a broadcast or unicast method of transmission.

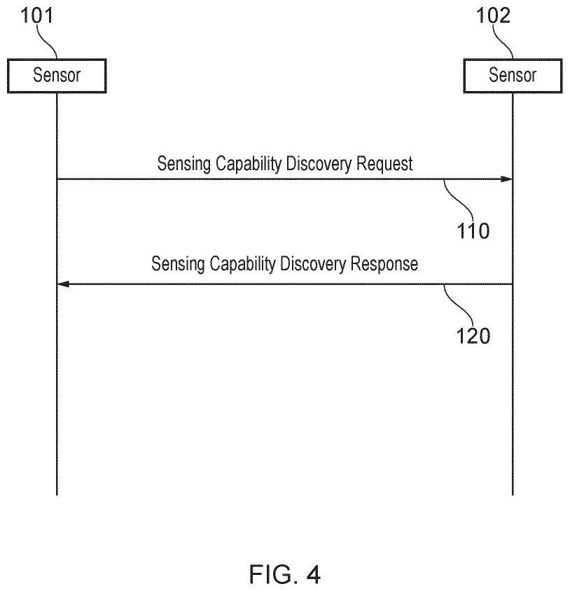

This example is shown graphically in FIG. 4. FIG. 4 shows a message flow diagram between a requesting communications device represented by Sensor 101 and a recipient communications device represented by Sensor 102. In a first step, the requesting communications device 101 sends a transmission 110 to the recipient communications device 102, which is a sensing capability discovery request. This request may, for example, request certain categories of sensing information from the recipient communications device, such as wide-angle radar data of a particular location in keeping with the example information categories outlined above.

The transmission 110 may be a broadcast transmission, in which case a broadcast message will be transmitted to trigger the process of sensing capability discovery. The broadcast transmissions may be receivable by one or more recipient communications devices 102. This message may be a D2D discovery message, or a newly defined sensing capability discovery message, and may include the requested sensing capabilities such as a sensing technology, sensing accuracy, sensing range, or if the sensor is able to coordinate or not. This discovery message 110 may be transmitted periodically or on demand. If the transmission is performed on demand, an indication will be included in the transmission 110 to indicate that the message is for sensing capability discovery in an initial request message. The sensors that receive this initial request message may broadcast in response their sensing capability in a sensing capability discovery message 120. This broadcasted sensing capability discovery response message 120 may also apply to transmission to a base station, a RSU, and a relay node as well as to other communications devices. For instance, if a base station has sensing capabilities, it can include, in the sensing capability discovery response message, information related to its sensing capabilities as on demand system information or as always on system information.

The above discussion, which relates to a broadcast mode of transmission of discovery request messages 110 can be extended to a groupcast mode. In this mode, a transmission 110 is transmitted to a group of receiving entities, which may include, for example, communications devices 102, base stations, road side units and/or relay nodes, and of which the requesting communications device 101 or sensor is a part. The message may be sent only within a group of which the requesting communications device 101 is already a part.

Alternatively, to a broadcast or groupcast mode, the communications device 101 may transmit signals requesting sensing capability discovery in a unicast mode. In this unicast mode the communications device 101 transmits a unicast request 110 to a single recipient, rather than a plurality of recipients as in the above mode, however, it will be appreciated that multiple unicast requests may be transmitted, each to a different recipient. Unicast mode may apply only to D2D communications devices that have established a PC5 connection with the recipient, or have a pre-existing remote UE-relay UE connection with the recipient. A sensing capability discovery request message 110 may be transmitted from one communications device 101 to another communications device 102 with which it has a PC5 connection.

In response to the sensing capability discovery request 110, the recipient communications device 102 may respond with a sensing capability discovery response 120 to provide an indication of the sensing capability that it can provide, in a unicast or broadcast mode. In some embodiments the recipient communications device 102 may provide an indication of which categories of data it can provide to the requesting communications device 101, or it may provide a single indication of whether it is able to fulfil the request of the requesting communications device 101. This transmission 120 is sent from the recipient communications device 102 to the requesting communications device 101. In response, the recipient of the request message 102 may transmit a reply message to the communications device 101. These messages may be transmitted in the form of a PC5 RRC signalling message, or in the form of user plane data. After receiving the response 120, the requesting communications device 101 may subsequently request sensing capability from other communications devices, although this is not shown in FIG. 4.

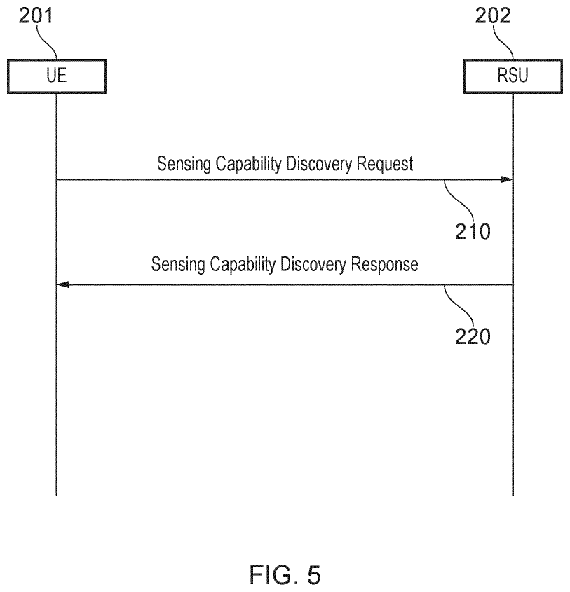

In a second example, signalling for sensing capability discovery may be performed in a central mode. In this central mode, the communications device communicates with a central unit, such as an infrastructure equipment forming part of the wireless communications network, in order to obtain sensing information. This is seen graphically in FIG. 5, which shows a message flow diagram between a communications device, represented as UE 201, and an infrastructure equipment, or central unit, connected to a wireless communications network, represented by RSU 202, however it should be appreciated that in the foregoing discussion the central unit may for example be a base station or a relay node or a RSU instead. Furthermore, it should be appreciated that, within the present disclosure, the term ‘communications device’ may refer to at least a user equipment or a sensor, as illustrated in FIGS. 4 and 5.

In a first step, the communications device 201 transmits to the central unit 202 a transmission of signals 210 representing a sensing capability discovery request. This request may be for sensing capability of the central unit 202 itself, or of sensing capability of other communications devices that report their sensing capability to the wireless communications network. For example, the communications device or sensor 201 may transmit a request to a central unit 202 for sensing capability information collected from neighbour communications devices of the central unit 202. This may be based on dedicated signalling for this purpose e.g. RRC signalling. During a connection setup process, or in another process following the setup process, sensors of the neighbour communications devices may report their sensing capability to the network, in other words, to the central unit 202, and this sensing capability information may be stored at the network or the central unit 202.

In addition, a neighbour communications device or a sensor thereof may be required to update the stored sensing capability information, for example by sending a transmission to the wireless communications network in order to update the sensing capability information, for example if the capability of the sensor changes. In an example, the neighbour communications device may be required to update the sensing capability information if it acquires new sensing capability information, or if the sensing capability of one or more sensors of the neighbour communications device are impaired compared to sensing capability associated with the previous sensing capability information. In this case, a requesting communications device 201 will include an indication of some information in its transmission of a sensing capability discovery request to the central unit 202, the information allowing the identification of other (neighbour) communications devices from which it requests sensing capability information. This may be in the form of location information of the communications devices of which sensing capability information is requested, a type of sensing capability information, or some other relevant identifier of communications devices.

This request may, for example, include
Location information of the communications device 201 that is requesting sensing capability. This enables the central unit 202 to send to the communications device 201 various capability information received from communications devices, sensors, that are nearby to this requesting communications device 201.
A preferred range or area in which the communications devices providing sensing capability are located. Only sensing capability related to communications devices in the preferred range or area may be sent to the requesting communications device 201.
A purpose for the request of capability information. This may enable the central unit 202 to better provide capability information to the communications device 201, and may be for example, for sensing coordination, for collaborative sensing, or another appropriate reason. The central unit 202 may be able to perform a greater proportion of processing of requesting appropriate sensing capability from other communications devices, which may have attendant benefits of reducing overall power consumption, wireless access interface interference etc.
A sensing capability requirement, e.g. based on specific sensing technology, sensing accuracy, sensing distance etc. The central unit 202 may then only send sensing capability information from sensors that conform to these requirements.

In response to receiving the sensing capability discovery request 210 the central unit 202 may transmit a sensing capability discovery response 220 as a reply message to the communications device 201. This reply message may include

Sensing capability information of the central unit 202/sensors that fulfil the requirements of the request from the communications device 201.
Synchronization information to enable the communications device 201 to determine the time at which the sensing capability information was recorded. For example, the sensing capability information may be time-stamped.
An indication related to any other conditions specified if the requesting communications device 201 determines that it wants to coordinate with the communications devices, that is, the sensors e.g. location information related to the sensors, grouping information related to the sensors etc.
Information related to identification of the neighbouring communications devices. This may take the form of providing a list of IDs for the neighbouring communications devices, such as those forming part of a group, to enable the communications device 201 to communicate with the neighbouring communications devices directly.

It should be appreciated that, in the above, as the present disclosure relates to the sharing of sensing capability information, the neighbouring communications devices are anticipated to have at least some function as sensors, and may be described as such. Therefore, the language of neighbouring communications devices may be understood to refer to the same entities as neighbouring sensors. The communications device 201 may also possess a function as a sensor, or it may operate without this function.

In some examples, the wireless communications network may configure the communications devices, sensors, when they are to send sensing capability discovery messages to the central unit or to a recipient communications device via dedicated signalling, e.g. via RRC signalling. The configurations may include
In a situation where a quality of link between the communications device, sensor, and the central unit, or between the recipient communications device and the requesting communications device exceeds a predetermined threshold e.g. a threshold number of missed sensing occasions etc.
When a sensing performance or result passes above or below a predetermined threshold e.g. a sensing accuracy is reduced beyond a threshold, a measure of braking in a vehicle exceeds a threshold acceleration value, etc.
In a broadcast or unicast mode, the network may determine and indicate to the sensor when, and in what conditions, broadcast or unicast mode may be prioritised above other modes.
In a D2D mode or central mode, the network may similarly determine and indicate to the sensor when, and in what conditions, D2D or central mode may be prioritised above other modes.

Based on the sensing capability discovery response, the communications device is able to decide with which, if any, communications device or sensor it will connect to in order to perform sharing of sensing capability and/or coordinated sensing.

In some examples, the wireless communications network may configure when the communications devices or sensors are to send sensing capability discovery messages to the central unit or to a recipient communications device, via direct Uu interface. A direct Uu interface is an interface between a user equipment, UE, and a radio access network, RAN. This means that a communications device, or UE, may send data to another UE (or group of UEs) via a base station (e.g. RSU) without the data passing through the core network, since the core network is connected to the RAN by another interface, for example the N1, N2, or N3 5G interfaces. The Uu interface was originally introduced for LTE V2X. A gNB (e.g. or RSU) may configure the Uu interface to the UE in advance. For example, a gNB may configure semi-persistence scheduling (downlink) and/or configured grant (uplink). After that, the UE can request sensing capability discovery via Uu at any time. A UE (or group of UEs) may then receive the sensing capability discovery response from the gNB (or RSU) with minimal delay.

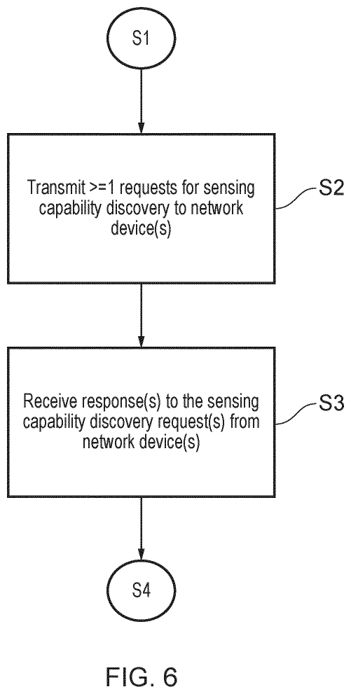

FIG. 6 depicts an example flow diagram representing one embodiment of the present technique to be performed by a communications device such as UE 201, Sensor 101, UE 14, or terminal 4. The flow diagram begins at a first step S1, before passing to a second step S2. In the second step, the communications device transmits to one or more network devices, which may be another communications device such as sensor 102 or a relay node, or may be an infrastructure equipment such as RSU 202, a request for sensing capability discovery. In particular, the communications device may transmit one or more such requests, which may be to the same network device and may relate to different requests (e.g. different sensing requested, different synchronization information, etc.), or may be to a plurality of network devices, where each individual network device may receive one or more requests.

The flow diagram, after this transmission step S2, then passes to a third step, S3. This step consists of the communications device receiving from the one or more network devices one or more responses to the sensing capability discovery requests. The number of responses may be different to the number of requests sent; the skilled person will appreciate that, for example, in some situations some network devices may not respond to the request (e.g. if the request is not received accurately, if the response is not transmitted accurately, or for other reasons) and the number of responses may be a smaller number than the number of requests transmitted. In other example situations, the communications device might request from an infrastructure equipment sensing information collected by communications devices associated with the infrastructure equipment, and, in this example situation, the number of responses may exceed the number of requests transmitted. The present technique is intended to cover both possibilities of the number of responses received exceeding, and subceeding, the number of requests transmitted. Following the response to the sensing capability discovery request, the flow diagram passes to a fourth step, S4, and terminates.

Those skilled in the art would further appreciate that such infrastructure equipment and/or communications devices as herein defined may be further defined in accordance with the various arrangements and examples discussed in the preceding paragraphs. It would be further appreciated by those skilled in the art that such infrastructure equipment and communications devices as herein defined and described may form part of communications systems other than those defined by the present disclosure.

The following numbered paragraphs provide further example aspects and features of the present technique:

### Paragraph 1

A method of operating a communications device configured to transmit signals to and/or receive signals from an infrastructure equipment of a wireless communications network and/or one or more other communications devices, the method comprising
transmitting, to one or more network devices, one or more requests for sensing capability discovery, the one or more network devices comprising the infrastructure equipment and/or the one or more other communications devices; and
receiving, from the one or more network devices, one or more responses to the sensing capability discovery request.

### Paragraph 2

The method of paragraph 1, wherein the sensing capability discovery request is transmitted in a broadcast transmission from the communications device.

### Paragraph 3

The method of paragraph 1, wherein the sensing capability discovery request is transmitted in a groupcast transmission from the communications device, the communications device being a part of a group to which the groupcast transmission is transmitted.

### Paragraph 4

The method of any preceding paragraph, wherein the one or more network devices comprise the one or more other communications device.

### Paragraph 5

The method of paragraph 1, wherein the sensing capability discovery request is transmitted in a unicast transmission from the communications device, the communications device and the one or more other communications device having already established a connection.

### Paragraph 6

The method of paragraph 5, wherein the connection between the communications device and the one or more other communications device is a PC5 connection.

### Paragraph 7

The method of paragraphs 1, 5, or 6, wherein the one or more other communications device includes a relay communications device.

### Paragraph 8

The method of paragraph 1, wherein the network device is the infrastructure equipment, and wherein the request for sensing capability discovery is a request for sensing capability discovery of the infrastructure equipment or of one or more neighbouring communications devices associated with the infrastructure equipment.

### Paragraph 9

The method of any preceding paragraph, wherein the transmitting one or more requests and/or the receiving one or more responses is via a direct Uu interface.

### Paragraph 10

The method of any preceding paragraph, wherein the communications device has a sensing capability and the one or more requests for sensing capability discovery comprise information related to the communications device's sensing capability.

### Paragraph 11

The method of any preceding paragraph, wherein the sensing capability discovery request comprises an indication of at least one of a location of the communications device, a range or area related to which the communications device requests information, a purpose for the transmission of the sensing capability discovery request, and a sensing capability requirement.

### Paragraph 12

The method of any preceding paragraph, wherein the sensing capability discovery request comprises a request for at least one of sensing capability information, synchronization information, one or more coordination conditions, and/or identification information.

### Paragraph 13

The method of any preceding paragraph, wherein the response to the sensing capability discovery request comprises an indication of at least one of sensing capability information, synchronization information, one or more coordination conditions, and identification information.

### Paragraph 14

The method of any preceding paragraph, wherein the communications device is configured to transmit the request for sensing capability discovery based on one or more of a radio link quality or a sensing performance falling below a predetermined threshold.

### Paragraph 15

The method of any preceding paragraph, wherein the communications device is configured by the wireless communications network, when certain predetermined conditions are satisfied, to transmit in a broadcast mode and when other certain predetermined conditions are satisfied, to transmit in a unicast or groupcast mode.

### Paragraph 16

The method of any preceding paragraph, wherein the communications device is configured by the wireless communications network, when certain predetermined conditions are satisfied, to transmit the one or more requests to the infrastructure equipment, and when other certain predetermined conditions are satisfied, to transmit the one or more requests to the one or more other communications devices.

### Paragraph 17

The method of any preceding paragraph, further comprising:
determining, based on the one or more responses, a set of communications devices to which the communication device is configured to transmit a request to participate in coordinated sensing.

### Paragraph 18

A communications device comprising
a transceiver configured to transmit signals to and/or receive signals from an infrastructure equipment of a wireless communications network and/or one or more other communications devices, and
a controller configured to control the transceiver to execute steps comprising:
transmitting, to one or more network devices, one or more requests for sensing capability discovery, the one or more network devices comprising the infrastructure equipment or the one or more other communications devices; and
receiving, from the one or more network devices, one or more responses to the sensing capability discovery request.

### Paragraph 19

Circuitry for a communications device comprising
transceiver circuitry configured to transmit signals to and/or receive signals form an infrastructure equipment of a wireless communications network and/or one or more other communications devices, and
controller circuitry configured to control the transceiver to execute steps comprising: transmitting, to one or more network devices, one or more requests for sensing capability discovery, the one or more network devices comprising the infrastructure equipment or the one or more other communications devices; and
receiving, from the one or more network devices, one or more responses to the sensing capability discovery request.

### Paragraph 20

A method of operating an infrastructure equipment configured to transmit signals to and/or receive signals from a communications device in a wireless communications network, the method comprising
receiving, from the communications device, a request for sensing capability discovery, and
transmitting, to the communications device, a response to the sensing capability discovery request.

### Paragraph 21

The method of paragraph 20, wherein the request for sensing capability discovery is a request for sensing capability discovery of one or more neighbouring communications devices neighbouring the communications device, and the neighbouring communications devices are associated with the infrastructure equipment.

### Paragraph 22

The method of paragraph 20 or paragraph 21, wherein the request for sensing capability discovery is a request for sensing capability discovery of the infrastructure equipment.

### Paragraph 23

A method of operating an infrastructure equipment configured to transmit signals to and/or receive signals from a communications device in a wireless communications network, the method comprising
transmitting, to the communications device, an indication of sensing capability of the infrastructure equipment and/or an indication of sensing capability of one or more neighbouring communications devices associated with the infrastructure equipment.

### Paragraph 24

The method of paragraph 23, wherein the transmission of the indication of sensing capability is transmitted via broadcast signalling.

### Paragraph 25

The method of paragraph 23, wherein the transmission of the indication of sensing capability is transmitted via a unicast or groupcast transmission.

### Paragraph 26

An infrastructure equipment comprising
a transceiver configured to transmit signals to and/or receive signals from a communications device in a wireless communications network, and
a controller configured to control the transceiver to execute steps comprising:
receiving, from the communications device, a request for sensing capability discovery, and
transmitting, to the communications device, a response to the sensing capability discovery request.

### Paragraph 27

Circuitry for an infrastructure equipment comprising
transceiver circuitry configured to transmit signals to and/or receive signals from a communications device in a wireless communications network, and
controller circuitry configured to control the transceiver circuitry to execute steps comprising:
receiving, from the communications device, a request for sensing capability discovery, and
transmitting, to the communications device, a response to the sensing capability discovery request.

### Paragraph 28

An infrastructure equipment comprising
a transceiver configured to transmit signals to and/or receive signals from a communications device in a wireless communications network, and
a controller, configured to control the transceiver to execute steps comprising: transmitting, to the communications device, an indication of sensing capability of the infrastructure equipment and/or an indication of sensing capability of one or more neighbouring communications devices associated with the infrastructure equipment.

### Paragraph 29

Circuitry for an infrastructure equipment comprising
transceiver circuitry configured to transmit signals to and/or receive signals from a communications device in a wireless communications network, and
   controller circuitry configured to control the transceiver circuitry to execute steps comprising:
transmitting, to the communications device, an indication of sensing capability of the infrastructure equipment and/or an indication of sensing capability of one or more neighbouring communications devices associated with the infrastructure equipment.

### Paragraph 30

A method of operating a communications device configured to transmit signals to and/or receive signals from an infrastructure equipment of a wireless communications network and/or one or more other communications devices, the method comprising
receiving, from one other communications device, a request for sensing capability discovery, and
transmitting, to the other communications device, a response to the sensing capability discovery request.

### Paragraph 31

The method of paragraph 30, wherein the sensing capability discovery request is received in a unicast transmission from the other communications device, the communications device and the other communications device having already established a connection.

### Paragraph 32

The method of paragraph 31, wherein the connection between the communications device and the one or more other communications device is a PC5 connection.

### Paragraph 33

A communications device comprising
a transceiver configured to transmit signals to and/or receive signals from an infrastructure equipment of a wireless communications network and/or one or more other communications devices, and a controller configured to control the transceiver to execute steps comprising: receiving, from one other communications device, a request for sensing capability discovery, and transmitting, to the other communications device, a response to the sensing capability discovery request.

### Paragraph 34

Circuitry for a communications device comprising
transceiver circuitry configured to transmit signals to and/or receive signals from an infrastructure equipment of a wireless communications network and/or one or more other communications devices, and
controller circuitry configured to control the transceiver circuitry to execute steps comprising:
receiving, from one other communications device, a request for sensing capability discovery, and transmitting, to the other communications device, a response to the sensing capability discovery request.

### Paragraph 35

A wireless communications system comprising a communications device according to paragraph 18 and an infrastructure equipment according to paragraph 26 or paragraph 28.

### Paragraph 36

A wireless communications system comprising at least one communications devices according to paragraph 18 and at least one communications device according to paragraph 33.

### Paragraph 37

A computer program comprising instructions which, when loaded onto a computer, cause the computer to perform a method according to paragraph 1, 20, 23, or 30.

### Paragraph 38

A non-transitory computer-readable storage medium storing a computer program according to paragraph 37.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### REFERENCES

[1] Holma H. and Toskala A, “LTE for UMTS OFDMA and SC-FDMA based radio access”, John Wiley and Sons, 2009.
[2] TR 38.913, “Study on Scenarios and Requirements for Next Generation Access Technologies (Release 14)”, 3rd Generation Partnership Project, v14.3.0, August 2017.
[3] S1-220191, “Study on Integrated Sensing and Communication”, 3^{rd} Generation Partnership Project, February 2022
[4] S1-221091, “Coordinated Sensing Operations”, 3^{rd} Generation Partnership Project, May 2022

1. A method of operating a communications device configured to transmit signals to and/or receive signals from an infrastructure equipment of a wireless communications network and/or one or more other communications devices, the method comprising
transmitting, to one or more network devices, one or more requests for sensing capability discovery, the one or more network devices comprising the infrastructure equipment or the one or more other communications devices: and
receiving, from the one or more network devices, one or more responses to the sensing capability discovery request.

2. The method of claim 1, wherein the sensing capability discovery request is transmitted in a broadcast transmission from the communications device.

3. The method of claim 1, wherein the sensing capability discovery request is transmitted in a groupcast transmission from the communications device, the communications device being a part of a group to which the groupcast transmission is transmitted.

4. The method of claim 1, wherein the one or more network devices comprise the one or more other communications device.

5. The method of claim 4, wherein the sensing capability discovery request is transmitted in a unicast transmission from the communications device, the communications device and the one or more other communications device having already established a connection.

6. The method of claim 5, wherein the connection between the communications device and the one or more other communications device is a PC5 connection.

7. The method of claim 5, wherein the one or more other communications device includes a relay communications device.

8. The method of claim 1, wherein the network device is the infrastructure equipment, and wherein the request for sensing capability discovery is a request for sensing capability discovery of the infrastructure equipment or of one or more neighbouring communications devices associated with the infrastructure equipment.

9. The method of claim 1, wherein the transmitting one or more requests and/or the receiving one or more responses is via a direct Uu interface.

10. The method of claim 1, wherein the communications device has a sensing capability and the one or more requests for sensing capability discovery comprise information related to the communications device's sensing capability.

11. The method of claim 1, wherein the sensing capability discovery request comprises an indication of at least one of a location of the communications device, a range or area related to which the communications device requests information, a purpose for the transmission of the sensing capability discovery request, and a sensing capability requirement.

12. The method of claim 1, wherein the sensing capability discovery request comprises a request for at least one of sensing capability information, synchronization information, one or more coordination conditions, and/or identification information.

13. The method of claim 1, wherein the response to the sensing capability discovery request comprises an indication of at least one of sensing capability information, synchronization information, one or more coordination conditions, and identification information.

14. The method of claim 1, wherein the communications device is configured to transmit the request for sensing capability discovery based on one or more of a radio link quality or a sensing performance falling below a predetermined threshold.

15. The method of claim 1, wherein the communications device is configured by the wireless communications network, when certain predetermined conditions are satisfied, to transmit in a broadcast mode and when other certain predetermined conditions are satisfied, to transmit in a unicast or groupcast mode.

16. The method of claim 1, wherein the communications device is configured by the wireless communications network, when certain predetermined conditions are satisfied, to transmit the one or more requests to the infrastructure equipment, and when other certain predetermined conditions are satisfied, to transmit the one or more requests to the one or more other communications devices.

17. The method of claim 1, further comprising:
determining, based on the one or more responses, a set of communications devices to which the communication device is configured to transmit a request to participate in coordinated sensing.

18.-25. (canceled)

26. An infrastructure equipment comprising
a transceiver configured to transmit signals to and/or receive signals from a communications device in a wireless communications network, and
a controller configured to control the transceiver to execute steps comprising:
receiving, from the communications device, a request for sensing capability discovery, and
transmitting, to the communications device, a response to the sensing capability discovery request.

27. (canceled)

28. An infrastructure equipment comprising
a transceiver configured to transmit signals to and/or receive signals from a communications device in a wireless communications network, and
a controller, configured to control the transceiver to execute steps comprising:
transmitting, to the communications device, an indication of sensing capability of the infrastructure equipment and/or an indication of sensing capability of one or more neighbouring communications devices associated with the infrastructure equipment.

29.-38. (canceled)
